(19) United States
(12) Patent Application Publication
(10) Pub. No.: US 2009/0065117 A1
(43) Pub. Date: Mar. 12, 2009

(54) TYRE COMPRISING AN EPOXIDIZED ELASTOMERIC POLYMER AND CROSSLINKABLE ELASTOMERIC COMPOSITION

(75) Inventors: Michela Caprio, Milano (IT); Maurizio Galimberti, Milano (IT); Lisa Grassi, Milano (IT); Stefano Testi, Milano (IT); Diego Tirelli, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI PNEUMATIC S.P.A., Milano (IT)

(21) Appl. No.: 11/658,510

(22) PCT Filed: Jul. 13, 2005
(86) PCT No.: PCT/EP2005/007607

§ 371 Date: Nov. 12, 2008

(30) Foreign Application Priority Data
Jul. 28, 2004 (EP) PCT/EP2004/008434

(51) Int. Cl. B60C 5/00; C08J 5/14

(52) U.S. Cl. 152/450; 523/152

(57) ABSTRACT

A tyre includes at least one structural element obtained by crosslinking a crosslinkable elastomeric composition including: (a) a crosslinkable elastomeric base comprising at least 10 phr, preferably from 30 phr to 100 phr, of (a₁) at least one epoxidized elastomeric polymer including less than 10 mol %, preferably from 0.1 mol % to 5 mol %, of epoxy groups relative to the total number of moles of monomers present in the elastomeric polymer; and (b) from 2 phr to 50 phr, preferably from 5 phr to 30 phr, of at least one layered material. Preferably, the at least one structural element is selected from bead filler, sidewall insert, tread underlayer, and tread base.

The present invention relates to a tyre and to a crosslinkable elastomeric composition.

More in particular the present invention relates to a tyre including at least one structural element obtained by crosslinking a crosslinkable elastomeric composition comprising at least one epoxidized elastomeric polymer and at least one layered material.

Moreover, the present invention also relates to a crosslinkable elastomeric composition comprising at least one epoxidized elastomeric polymer and at least one layered material, as well as to a crosslinked manufactured article obtained by crosslinking said crosslinkable elastomeric composition.

In the rubber industry, in particular that of tyres for vehicle wheels, it is known practice to add organic fibres such as, for example, polyamide fibres (in particular, aromatic polyamide fibres known as “aramide fibres”), polyester fibres or polyolefin fibres, to elastomeric compositions, in order to improve their mechanical properties (both static and dynamic).

For example, European Patent Application EP 691,218 discloses a tyre component for a pneumatic tyre comprising a reinforced vulcanizable composition, said composition including a vulcanizable elastomeric matrix material having dispersed therein an effective reinforcing amount of partially oriented fibres having a modulus of less than 10 GPa, preferably less than 6 GPa. As an alternative embodiment, a tyre component may be reinforced with a mixture of a partially oriented fibres and fibrillated pulp fibres (i.e. Kevlar® pulp). The partially oriented fibres may comprise as specific examples, polyamides, polyesters, polyolefins, and a polymer selected from the group consisting of nylon 6, nylon 46, nylon 66, polyethylene, polypropylene, polyethylene-terephthalate (PET). The above mentioned reinforced vulcanizable composition is said to have an improved stiffness without negatively affecting its remaining properties such as, for example, hysteresis and fatigue endurance.

International Patent Application WO 02/24596 in the name of the Applicant discloses a tyre with an elastomeric intermediate layer disposed between the tread band and the belted plies wherein the elastomeric intermediate layer is made of a fibre-reinforced material. Said elastomeric intermediate layer may be reinforced with short reinforcing fibres such as, for example, aramide fibres (i.e. Kevlar© pulp) to improve its modulus of elasticity, among other mechanical properties.

The mechanical properties of the elastomeric compositions may be also improved by increasing crosslinking density of the elastomeric composition by using a large amount of sulphur; or by using a large amount of carbon black, or a very fine and structured carbon black which has a high reinforcing capacity.

However, the above ways of improving mechanical properties may lead to a number of drawbacks.

For example, the addition of organic fibres due to their poor dispersion, may impair the processability of the uncured elastomeric compositions and therefore the quality of the finished product, both in term of mechanical properties and of surface appearance. This may cause a reduction in their tear resistance and detachments from the other elastomeric compositions present in the tyre both during manufacturing process or during use of the tyre. Moreover, the organic fibres have a remarkable anisotropic behaviour, namely they substantially orient in the direction of the shear forces exerted during extrusion and calendering of the uncured elastomeric composition to form a layer of elastomeric material (usually named “calendering direction”), so as to give to the tyre essentially a longitudinal reinforcement, namely a reinforcement essentially in the circumferential direction of the tyre.

On the other hand, the use of a large amount of sulphur may cause remarkable reversion phenomena, which result in modifications of the tyre performances during use. On the other side, it is known that carbon black gives pronounced hysteresis properties to the elastomeric composition, namely an increase in the dissipated heat under dynamic conditions, which results in an increase in the rolling resistance of the tyre. In addition, a large amount of carbon black remarkably increases viscosity of the non-crosslinked elastomeric composition and, consequently, has a negative impact on its processability and extrudability.

Therefore, other ways have been found to improve mechanical properties of the elastomeric compositions.

For example, European Patent Application EP 1,193,085 relates to a tyre with a rubber/cord laminate, sidewall insert and apex including a rubber composition comprising, based upon parts by weight of an ingredient per 100 parts by weight elastomer (phr):
(A) 100 phr of at least one diene-base elastomer;
(B) 30 phr to 100 phr of particulate reinforcement dispersed within said elastomer(s) selected from intercalated smectite, preferably montmorillonite, clay particles, carbon black, synthetic amorphous silica and silica treated carbon black, comprised of:
   (1) 1 phr to 10 phr of said intercalated, layered, thin, substantially two dimensional smectite, preferably montmorillonite, clay particles of which at least a portion thereof is in a form of thin, flat, substantially two dimensional exfoliated platelets derived from said intercalated clay; and
   (2) 20 phr to 99 phr of at least one additional reinforcing filler comprised of carbon black, synthetic amorphous silica and silica treated carbon black.

The abovementioned rubber composition is said to have improved stiffness and tensile modulus with only a small increase of Tandelta values.

Japanese Patent Application JP 2003/221473 relates to a rubber composition wherein a compound containing maleic anhydride groups and a lamellar clay mineral which has been treated with a primary and/or secondary ammonium ions is mixed with a solid rubber. Compounds containing maleic anhydride groups useful for said purpose are maleic anhydride or maleinized liquid rubbers having a molecular weight≦30,000. Solid rubbers useful for said purpose are natural rubber, synthetic rubber, thermoplastic elastomers, or mixtures thereof. The above-mentioned lamellar clay mineral is said to be uniformly and finely dispersed in said rubber composition.

United States Patent Application US 2003/0191224 relates to an organically modified layered clay ionically bonded with an organic compound having an ammonium group and an amino group and to an organic polymer composition containing the same. Said organic polymer composition comprises (i) an organic polymer, (ii) said organically modified layered clay, and (iii) a low molecular weight organic polymer having a weight average molecular weight of less than 50,000 and/or a high molecular weight organic polymer having a weight average molecular weight of 50,000 or more, each having a functional group capable of reacting with an amino group. Examples of functional groups capable of reacting with an amino group are: acid anhydride group, epoxy group, halogen group, carboxyl group, acyl group, methacryl group, isocyanate group, ester group. The abovementioned organic polymer composition, having good abrasion resistance and air barrier properties, is said to be useful, for example, for making tread, carcass or innerliner, of a pneumatic tyre.

United States Patent Application 2003/0004250 relates to a light weight rubber composition comprising (1) an amino group containing rubbery polymer, wherein said amino group containing rubbery polymer contains from about 0.1 weight percent to about 20 weight percent of a monomer containing an amino group, and (2) from about 0.1 phr to about 25 phr of a 2:1 layered silicate clay. The abovementioned rubber composition, having improved tensile strength and elongation at break, is said to be useful in the manufacturing of rubber articles such as power transmission belts and tyres, in particular tyre tread band and sidewalls.

United States Patent Application US 2003/0144401 relates to nanocomposites comprising a functionalized elastomeric polymer which contains a particulate dispersion therein of an intercalated and at least partially exfoliated, swellable clay such as, for example, montmorillonite clay. Said clay may be pre-intercalated and thereafter blended with, or intercalated and partially exfoliated in situ within, a functionalized elastomer in an aqueous medium, wherein said functionalized elastomer contains at least one functional group selected from acid, acid salts, anhydride, and protonated amine-modified epoxy groups. Said nanocomposite is further blended with at least one additional diene-based elastomer. Articles of manufacture, including industrial belts and tyres, having at least one component including such nanocomposite where such component may be a coating thereon or other integral component, are also disclosed. Such tyre component may be, for example, a tyre tread band, a tyre sidewall and/or a tyre innerliner.

International Patent Application WO 2004/005388 relates to a nanocomposite comprising a clay and an elastomer comprising C₂ to C₁₀ olefin derived units, wherein said elastomer also comprises functionalized monomer units pendant to the elastomer. Preferably, the elastomer is selected from poly(isobutylene-co-p-alkylstyrene) elastomers and poly(isobutylene-co-isoprene) elastomers, which are functionalized by reacting free radical generating agents and unsaturated carboxylic acids, unsaturated esters, unsaturated imides, and the like, with the elastomer. The abovementioned nanocomposite is said to have improved air barrier properties and to be particularly useful for tyre innerliner and innertubes.

The Applicant has noticed that, in particular in the case of elastomeric compositions which usually require a high reinforcement such as those used, for example, for making bead fillers, sidewall inserts, tread underlayers, tread base, the use of a layered material as reinforcing filler may not be sufficient to achieve the desired properties.

In order to achieve more reinforcement, a large amount of layered material may be used. However, some drawbacks may be encountered such as, for example, a decrease in tearing resistance and, in particular in the case of layered material previously treated with a compatibilizing agent (for example, a quaternary ammonium or phosphonium salt) a premature crosslinking of the elastomeric compositions (scorching phenomena). Moreover, a scarce adhesion to other elastomeric structural elements of the tyre is observed, and consequently detachments in the tyre structure may occur both during manufacturing and during use.

The Applicant has now found that it is possible to obtain crosslinkable elastomeric compositions that may be advantageously used in the production of crosslinked manufactured products, in particular in the manufacturing of tyres, more in particular in the manufacturing of inner structural elements of a tyre, by using at least one epoxidized elastomeric polymer having a low epoxidation degree and at least one layered material.

The crosslinked elastomeric compositions show improved mechanical properties, both static (in particular tensile modulus) and dynamic (in particular, elastic modulus). Moreover, an improved hardness is achieved. Said improvements are obtained without negatively affecting the hysteresis properties of the crosslinked elastomeric compositions. In addition, also the viscosity values of said crosslinkable elastomeric compositions are not negatively affected so allowing a good processability and extrudability of the same.

According to a first aspect, the present invention relates to a tyre comprising at least one structural element obtained by crosslinking a crosslinkable elastomeric composition comprising:
(a) a crosslinkable elastomeric base comprising at least 10 phr, preferably from 30 phr to 100 phr, of (a₁) at least one epoxidized elastomeric polymer including less than 10 mol %, preferably from 0.1 mol % to 5 mol %, of epoxy groups relative to the total number of moles of monomers present in the elastomeric polymer;
(b) from 2 phr to 50 phr, preferably from 5 phr to 30 phr, of at least one layered material.

Preferably, said layered material has an individual layer thickness of from 0.01 nm to 30 nm, more preferably from 0.05 nm to 15 nm.

Said epoxy groups may be in the main chain and/or in the side chain of the elastomeric polymer.

The amount of the epoxy groups present on the epoxidized elastomeric polymer may be determined according to known techniques such as, for example, by means of ¹H-NMR analysis, or by hydrolysis of the epoxy groups and subsequent functionalization of the obtained hydroxyl groups by agents which are active to UV fluorescence analysis: further details about said techniques will be reported in the examples which follow.

For the purpose of the present description and of the claims which follow, the term “crosslinkable elastomeric base” means any polymer or polymers mixture, either natural or synthetic, capable of assuming all the chemical-physical and mechanical properties typical of elastomeric polymers as a result of crosslinking with system known in the art such as, for example, a sulphur-based system or a peroxide-based system.

For the purposes of the present description and of the claims which follow, the term “phr” means the parts by weight of a given component of the elastomeric composition per 100 parts by weight of the elastomeric base.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

According to one preferred embodiment, the tyre comprises:
a carcass structure of a substantially toroidal shape, having opposite lateral edges associated with respective right-hand and left-hand bead structures, said bead structures comprising at least one bead core and at least one bead filler;
a belt structure applied in a radially external position with respect to said carcass structure;
a tread band radially superimposed on said belt structure;
a pair of sidewalls applied laterally on opposite sides with respect to said carcass structure;
at least one structural element selected from bead filler, sidewall insert, tread underlayer, tread base, obtained by crosslinking a crosslinkable elastomeric composition above disclosed.

According to a further preferred embodiment, said sidewall insert extends radially from a position corresponding to the bead structure to a position corresponding to a tread lateral edge. Said sidewall insert is usually used in the case of extended mobility tyres such as, for example, run flat tyres.

According to a further preferred embodiment, said tread underlayer is a layer of crosslinked elastomeric composition applied in a radially internal position with respect to said tread band.

According to a further preferred embodiment, said tread band is of cap and base construction and comprises a radially inner layer or tread base and a radially outer layer or tread cap. Preferably, said radially inner layer or tread base has a thickness of at least 10%, preferably of from 20% to 70%, with respect to the total thickness of the tread band.

Preferably, said structural element has a tensile modulus at 100% elongation (100% Modulus) not lower than 3 MPa, preferably of from 4.5 MPa to 16 MPa.

Preferably, said structural element has a dynamic elastic modulus (E′), measured at 23° C., not lower than 12 MPa, more preferably of from 13 MPa to 50 MPa.

Preferably, said structural element has a dynamic elastic modulus (E′), measured at 70° C., not lower than 8 MPa, more preferably from 9 MPa to 40 MPa.

Preferably, said structural element has a IRHD hardness, measured at 23° C. not lower than 70, more preferably from 75 to 95.

The tensile modulus may be measured according to Standard ISO 37:1994. The dynamic elastic modulus (E′) may be measured using an Instron dynamic device in the traction-compression mode. The IRHD hardness may be measured according to Standard ISO 48:1994. Further details regarding the above measurement methods will be given in the examples which follow.

According to a further aspect, the present invention relates to a crosslinkable elastomeric composition comprising:
(a) a crosslinkable elastomeric base comprising (a₁) at least 10 phr, preferably from 30 phr to 100 phr, of at least one epoxidized elastomeric polymer including less than 10 mol %, preferably from 0.1 mol % to 5 mol %, of epoxy groups relative to the total number of moles of monomers present in the elastomeric polymer;
(b) from 2 phr to 50 phr, preferably from 5 phr to 30 phr, of at least one layered material.

According to one preferred embodiment, said crosslinkable elastomeric base (a), further comprises (a₂) at least one second elastomeric polymer in an amount not higher than 90 phr, preferably of from 0 phr to 70 phr.

According to one preferred embodiment, said elastomeric composition may further comprise (c) at least one carbon black reinforcing filler.

According to a further preferred embodiment, said elastomeric composition may further comprise (d) at least one silane coupling agent.

According to a further aspect, the present invention relates to a crosslinked manufactured article obtained by crosslinking a crosslinkable elastomeric composition above reported.

With regard to the epoxidized elastomeric polymer (a₁), the epoxy groups may be introduced into the elastomeric polymer according to known techniques.

For example, the epoxy groups may be introduced during the production of the elastomeric polymer, by co-polymerization with at least one epoxy compound containing at least one ethylenic unsaturation. Examples of epoxy compounds containing at least one ethylenic unsaturation are: glycidyl acrylate, glycidyl methacrylate, itaconic acid monoglyciyl ester, maleic acid glycidyl ester, vinylglycidyl ether, allylglycidyl ether, or mixtures thereof.

Alternatively, it is possible to introduce the epoxy groups by reacting the elastomeric polymer, in solution, with at least one epoxidizing agent. This epoxidizing agent is, generally, a peroxide, a peracid or a derivative thereof, in particular a salt thereof (for example, performic acid, perpropionic acid, peracetic acid, m-chloroperbenzoic acid, metal salts of peroxybenzoic acid such as, for example, magnesium bis(2-carboxylate-monoperoxybenzoic acid)hexahydrate) or, alternatively, hydrogen peroxide in the presence of a carboxylic acid or a derivative thereof, in particular anhydrides for example, acetic acid, formic acid, propionic acid, acetic anhydride), optionally mixed with an acid catalyst (for example; sulphuric acid).

Further details regarding processes for epoxidizing elastomeric polymers are disclosed, for example, in patent U.S. Pat. No. 4,341,672 or by Schulz et al. in “Rubber Chemistry and Technology”, Vol. 55, pages 809 et seq.

Preferably, the epoxy groups may be introduced into the elastomeric polymer by means of a process comprising the following steps:
feeding at least one elastomeric polymer and at least one epoxidizing agent to a mixing device;
mixing and softening said mixture obtaining an epoxidized elastomeric polymer;
discharching the obtained epoxidized elastomeric polymer from said mixing device.

Alternatively, the epoxy groups may be introduced into the elastomeric polymer by means of a process comprising:
feeding at least one elastomeric polymer to a mixing device;
feeding at least one hydrogen peroxide precursor to said mixing device;
feeding at least one carboxylic acid or a derivative thereof to said mixing device;
mixing and reacting, in the presence of water, said at least one elastomeric polymer with said at least one hydrogen peroxide precursor and said at least one carboxylic acid or a derivative thereof, to obtain an epoxidized elastomeric polymer;
discharging the resulting epoxidized elastomeric polymer from said mixing device.

Preferably, the mixing device may be selected from: open internal mixers such as, for example, open-mills; internal mixers such as, for example, Haake Rheocord internal mixer, or internal mixers of the type with tangential rotors (Banbury) or with interlocking rotors (Intermix); continuous mixers of Ko-Kneader type (Buss); co-rotating or counter-rotating twin-screw extruders. More preferably, the mixing device is a co-rotating twin-screw extruder.

Preferably, said process may be carried out at a temperature of from 15° C. to 200° C., preferably of from 50° C. to 180° C.

Preferably, said process may be carried out for a time of from 10 seconds to 30 minutes, preferably of from 30 seconds to 20 minutes.

Preferably, the epoxidizing agent may be selected from those above reported.

Preferably, the hydrogen peroxide precursor may be selected, for example, from inorganic persalts (for example, sodium perborate mono- and tetra-hydrate, sodium percarbonate, potassium peroxymonosulfate), metal peroxides (for example, magnesium peroxide, calcium peroxide, zinc peroxide), hydrogen peroxide adducts (for example, urea/hydrogen peroxide adduct), or mixtures thereof.

Preferably the carboxylic acid or a derivative thereof may be selected, for example, from acetic acid, acetic anhydride, maleic acid, maleic anhydride, succinic acid, succinic anhydride, phthalic acid, phthalic anhydride, or mixtures thereof.

Said epoxidized elastomeric polymer may be obtained in the form of a continuous ribbon or, alternatively, in the form of a subdivided product.

According to one preferred embodiment, the elastomeric polymer which may be utilized in the production of the epoxidized elastomeric polymer (a₁), may be selected from those commonly used in sulphur-crosslinkable elastomeric compositions, that are particularly suitable for producing tyres, that is to say from elastomeric polymers or copolymers with an unsaturated chain having a glass transition temperature (T_{g}) generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene and isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Preferably, the elastomeric polymer may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

Alternatively, elastomeric polymer of one or more monoolefins with an olefinic comonomer and at least one diene, or derivatives thereof, may be used. The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene/diene copolymers (EPDM); polyisobutene; butyl rubbers; halobutyl rubbers, in particular chlorobutyl or bromobutyl rubbers; or mixtures thereof.

Elastomeric polymers functionalized by reaction with suitable terminating agents or coupling agents may also be used. In particular, the elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European patent EP 451,604, or patents U.S. Pat. No. 4,742,124 and U.S. Pat. No. 4,550,142).

The average molecular weight of the elastomeric polymer which may be utilized in the production of the epoxidized elastomeric-polymer (a₁) is, preferably, of from 2000 to 1,000,000, more preferably of from 50,000 to 500,000.

According to one preferred embodiment, said epoxidized elastomeric polymer (a₁) is pre-mixed with the layered material in order to obtain a masterbatch.

Preferably, said masterbatch may be obtained by means of a process comprising the following steps:
feeding at least one epoxidized elastomeric polymer (a₁) and at least one layered material to a mixing device;
mixing and softening said mixture obtaining a masterbatch;
discharching the obtained masterbatch from said mixing device.

Alternatively, said masterbatch may be obtained by means of a process comprising the following steps:
feeding at least one elastomeric polymer, at least one epoxidizing agent, and at least one layered material, to a mixing device;
mixing and softening said mixture obtaining a masterbatch;
discharching the obtained masterbatch from said mixing device.

Alternatively, said masterbatch may be obtained by means of a process comprising the following steps:
feeding at least one elastomeric polymer to a mixing device;
feeding at least one hydrogen peroxide precursor to said mixing device;
feeding at least one carboxylic acid or a derivative thereof to said mixing device;
mixing and reacting, in the presence of water, said at least one elastomeric polymer with said at least one hydrogen peroxide precursor and said at least one carboxylic acid or a derivative thereof;
feeding at least one layered inorganic material to said mixing device;
mixing and softening said mixture obtaining a masterbatch;
discharching the obtained masterbatch from said mixing device.

Preferably, the mixing device may be selected from: open internal mixers such as, for example, open-mills; internal mixers such as, for example, Haake Rheocord internal mixer, or internal mixers of the type with tangential rotors (Banbury) or with interlocking rotors (Intermix); continuous mixers of Ko-Kneader type (Buss); co-rotating or counter-rotating twin-screw extruders. More preferably, the mixing device is a co-rotating twin-screw extruder.

Said elastomeric polymer may be selected from the elastomeric polymers or copolymers above reported.

Said epoxidixing agent, hydrogen peroxide precursor, carboxylic acid or a derivative thereof, may be selected from those above reported.

Said masterbatch may be obtained in the form of a continuous ribbon or, alternatively, in the form of a subdivided product.

Preferably, said process may be carried out at a temperature of from 20° C. to 220° C., preferably of from 40° C. to 200° C.

Preferably, said process may be carried out for a time of from 10 seconds to 5 minutes, preferably of from 20 seconds to 3 minutes.

According to one preferred embodiment, the layered material (b) which may be used in the present invention may be selected, for example, from phyllosilicates such as: smectites, for example, montmorillonite, bentonite, nontronite, beidellite, volkonskoite, hectorite, saponite, sauconite; vermiculite; halloisite; sericite; aluminate oxides; hydrotalcite; or mixtures thereof. Montmorillonite is particularly preferred. These layered material generally contains exchangeable cations such as sodium (Na⁺), calcium (Ca²⁺), potassium (K⁺), or magnesium (Mg²⁺) present at the interlayer surfaces.

In order to render the layered material more compatible with the elastomeric polymer said layered material (b) may be treated with at least one compatibilizing agent. Said compatibilizing agent is capable of undergoing ion exchange reactions with the cations present at the interlayers surfaces of the layered inorganic material.

According to one preferred embodiment, said compatibilizing agent may be selected, for example, from the quaternary ammonium or phosphonium salts having general formula (I):

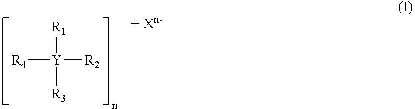

wherein:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH wherein R₅ represents a linear or branched C₁-C₂₀ alkylene group; a C₆-C₁₈ aryl group; a C₇-C₂₀ arylalkyl or alkylaryl group; a C₅-C₁₁ cycloalkyl group, said cycloalkyl group possibly containing hetero atom such as oxygen, nitrogen or sulphur;
Xⁿ⁻ represents an anion such as the chlorine ion, the sulphate ion or the phosphate ion;
   n represents 1, 2 or 3.

The layered material (b) may be treated with the compatibilizing agent before adding it to the elastomeric base (a). Alternatively, the layered material (b) and the compatibilizing agent may be separately added to the elastomeric base (a).

The treatment of the layered material (b) with the compatibilizing agent may be carried out according to known methods such as, for example, by an ion exchange reaction between the layered material and the compatibilizer: further details are described, for example, in patents U.S. Pat. No. 4,136,103, U.S. Pat. No. 5,747,560, or U.S. Pat. No. 5,952,093.

Example of layered material (b) which may be used according to the present invention and is available commercially is the product known by the name of Dellite® 67G from Laviosa Chimica Mineraria S.p.A.

As reported above, the polymeric base (a), may further comprises at least one second elastomeric polymer (a₂). Said elastomeric polymer (a₂) may be selected from the elastomeric polymers or copolymers above reported. Among those, the preferred elastomeric polymers (a₂) are:
cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof;
ethylene/propylene/diene copolymers (EPDM); polyisobutene; butyl rubbers; halobutyl rubbers, in particular chlorobutyl or bromobutyl rubbers; or mixtures thereof.

Elastomeric polymers of one or more monoolefins with an olefinic comonomer such as, for example, ethylene/propylene copolymers (EPR), or mixtures thereof, may also be used as elastomeric polymers (a₂).

As disclosed above, said elastomeric composition may further comprise (c) at least one carbon black reinforcing filler.

According to one preferred embodiment, the carbon black reinforcing filler which may be used in the present invention may be selected from those having a surface area of not less than 20 m²/g (determined by CTAB absorption as described in Standard ISO 6810:1995).

According to one preferred embodiment, said carbon black reinforcing filler is present in the elastomeric composition in an amount of from 0 phr to 120 phr, preferably of from 20 phr to 90 phr.

As disclosed above, said elastomeric composition may further comprise (d) at least one silane coupling agent.

According to one preferred embodiment, the silane coupling agent which may be used in the present invention may be selected from those having at least one hydrolizable silane group which may be identified, for example, by the following general formula (II):

(R)₃Si—CₙH₂ₙ—X (II)

wherein the groups R, which may be identical or different,

are selected from: alkyl, alkoxy or aryloxy groups or from halogen atoms, on condition that at least one of the groups R is an alkoxy or aryloxy group; n is an integer between 1 and 6 inclusive; X is a group selected from: nitroso, mercapto, amino, epoxide, vinyl, imide, chloro, —(S)ₘCₙH₂ₙ—Si—(R)₃, or —S—COR, in which m and n are integers between 1 and 6 inclusive and the groups R are defined as above.

Among the silane coupling agents that are particularly preferred are bis(3-triethoxysilyl-propyl)tetrasulphide and bis(3-triethoxysilylpropyl)-disulphide. Said coupling agents may be used as such or as a suitable mixture with an inert filler (for example carbon black) so as to facilitate their incorporation into the elastomeric base (a).

According to one preferred embodiment, said silane coupling agent is present in the elastomeric composition in an amount of from 0 phr to 10 phr, preferably of from 0.5 phr to 5 phr.

At least one additional reinforcing filler may advantageously be added to the above reported elastomeric composition, in an amount generally of from 0.1 phr to 120 phr, preferably of from 20 phr to 90 phr. The reinforcing filler may be selected from those commonly used for crosslinked manufactured products, in particular for tyres, such as, for example, silica, alumina, aluminosilicates, calcium carbonate, kaolin, or mixtures thereof.

The silica which may be used in the present invention may generally be a pyrogenic silica or, preferably, a precipitated silica, with a BET surface area (measured according to ISO standard 5794/1) of from 50 m²/g to 500 m²/g, preferably of from 70 m²/g to 200 m²/g.

When a reinforcing filler comprising silica is present, the elastomeric composition may advantageously incorporate a further silane coupling agent capable of interacting with silica and of linking it to the elastomeric polymer during the vulcanization. Examples of silane coupling agents which may be used have been already disclosed above.

The elastomeric composition above reported may be vulcanized according to known techniques, in particular with sulphur-based vulcanizing systems commonly used for elastomeric polymers. To this end, in the composition, after one or more steps of thermomechanical processing, a sulphur-based vulcanizing agent is incorporated together with vulcanization accelerators. In the final processing step, the temperature is generally kept below 120° C. and preferably below 100° C., so as to avoid any unwanted pre-crosslinking phenomena.

The vulcanizing agent most advantageously used is sulphur, or molecules containing sulphur (sulphur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof.

Accelerators that are commonly used may be selected from: dithiocarbamates, guanidine, thiourea, thiazoles, sulphenamides, thiurams, amines, xanthates, or mixtures thereof.

Said elastomeric composition may comprise other commonly used additives selected on the basis of the specific application for which the composition is intended. For example, the following may be added to said elastomeric composition: antioxidants, anti-ageing agents, plasticizers, adhesives, anti-ozone agents, modifying resins, fibres (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to said elastomeric composition. The amount of plasticizer generally ranges from 0 phr to 70 phr, preferably from 5 phr to 30 phr.

The above reported elastomeric composition may be prepared by mixing together the elastomeric base components and the layered material or a masterbatch thereof, with the reinforcing filler and the other additives optionally present, according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss), or of co-rotating or counter-rotating twin-screw type.

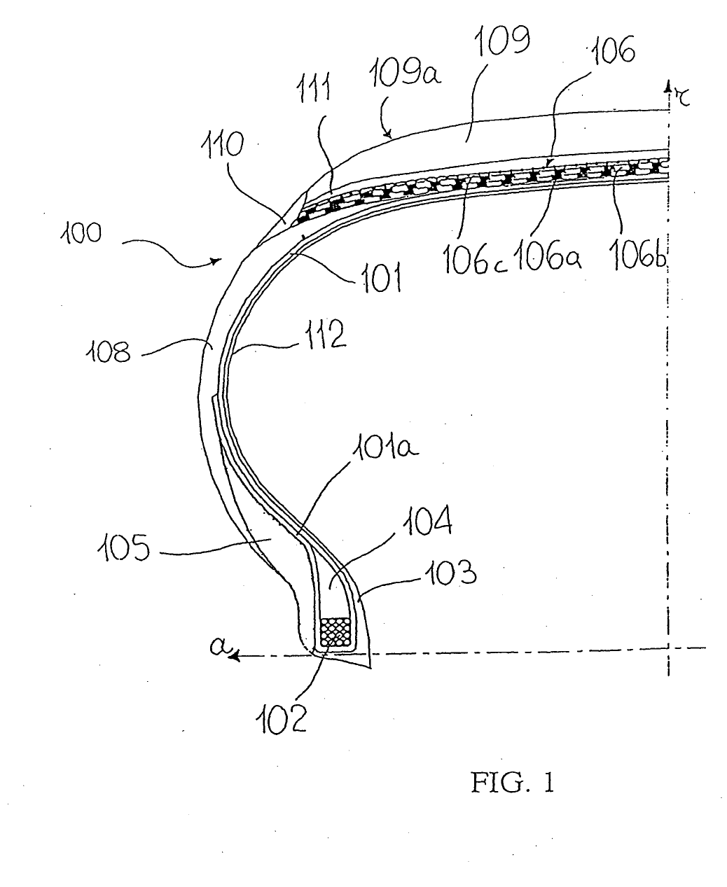

The present invention will now be illustrated in further detail by means of a number of illustrative embodiments, with reference to the attached FIG. 1-4:

FIG. 1-4 are a view in cross section of a portion of a tyre made according to the invention;

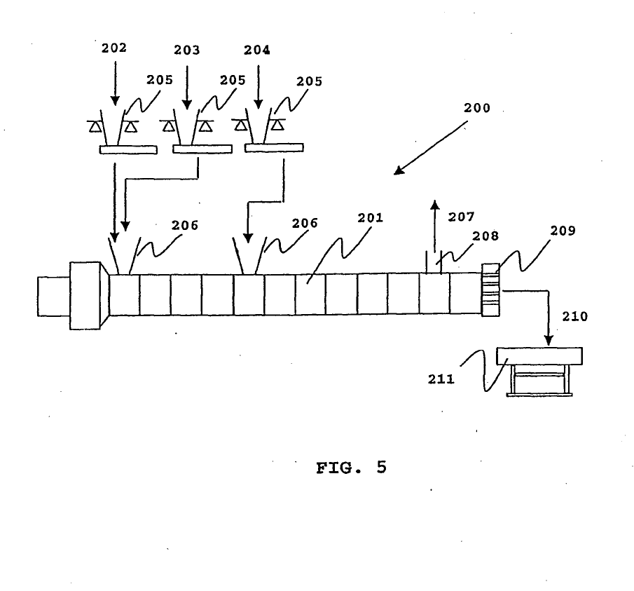

FIG. 5 is a schematic diagram of a production plant for making a masterbatch according to the process of the present invention.

“a” indicates an axial direction and “r” indicates a radial direction. For simplicity, FIG. 1 shows only a portion of the tyre, the remaining portion not represented being identical and symmetrically arranged with respect to the radial direction “r”.

The tyre (100) comprises at least one carcass ply (101), the opposite lateral edges of which are associated with respective bead structures comprising at least one bead core (102) and at least one bead filler (104). The association between the carcass ply (101) and the bead core (102) is achieved here by folding back the opposite lateral edges of the carcass ply (101) around the bead core (102) so as to form the so-called carcass back-fold (101a) as shown in FIG. 1.

Alternatively, the conventional bead core (102) may be replaced with at least one annular insert formed from rubberized wires arranged in concentric coils (not represented in FIG. 1) (see, for example, European Patent Applications EP 928, 680 and EP 928, 702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of elastomeric composition. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. The core (102) is enclosed in a bead (103), defined along an inner circumferential edge of the tyre (100), with which the tyre engages on a rim (not represented in FIG. 1) forming part of a vehicle wheel. The space defined by each carcass back-fold (101a) contains a bead filler (104) which may be made according to the present invention, wherein the bead core (102) is embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109) has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A tread underlayer (111) which may be made according to the present invention, is placed between the belt structure (106) and the tread band (109).

As represented in FIG. 1, the tread underlayer (111) may have uniform thickness.

Alternatively, the tread underlayer (111) may have a variable thickness in the transversal direction. For example, the thickness may be greater near its outer edges than at a central zone.

In FIG. 1, said tread underlayer (111) extends over a surface substantially corresponding to the surface of development of said belt structure (106). Alternatively, said tread underlayer (111) extends only along at least one portion of the development of said belt structure (106), for instance at opposite side portions of said belt structure (106) (not represented in FIG. 1).

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109).

In the case of tubeless tyres, a rubber layer (112) generally known as a liner, which provides the necessary impermeability to the inflation air of the tyre, may also be provided in an inner position relative to the carcass ply (101).

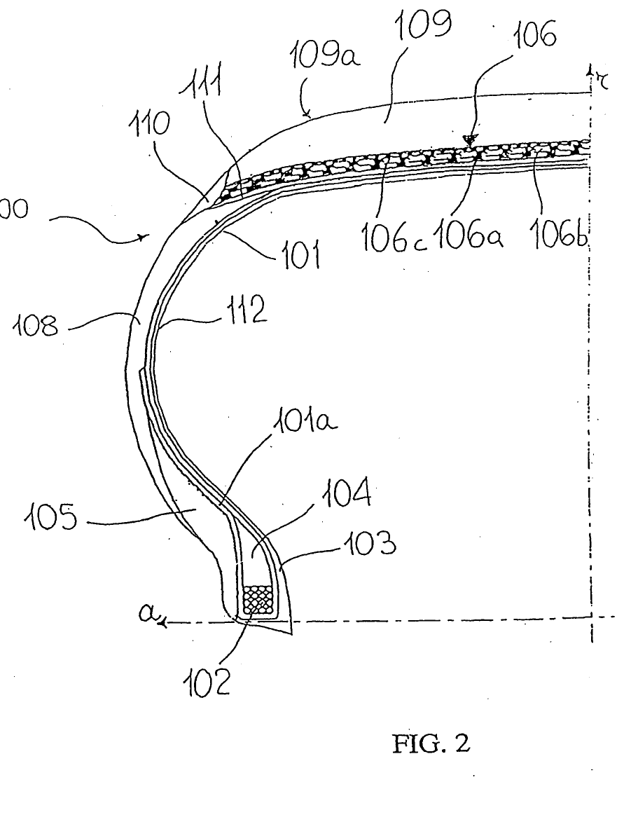

FIG. 2, shows a tyre (100) having a structure as described in FIG. 1 where the tread underlayer (111) which may be made according to the present invention, is placed between the belt structure (106) and the carcass ply (101).

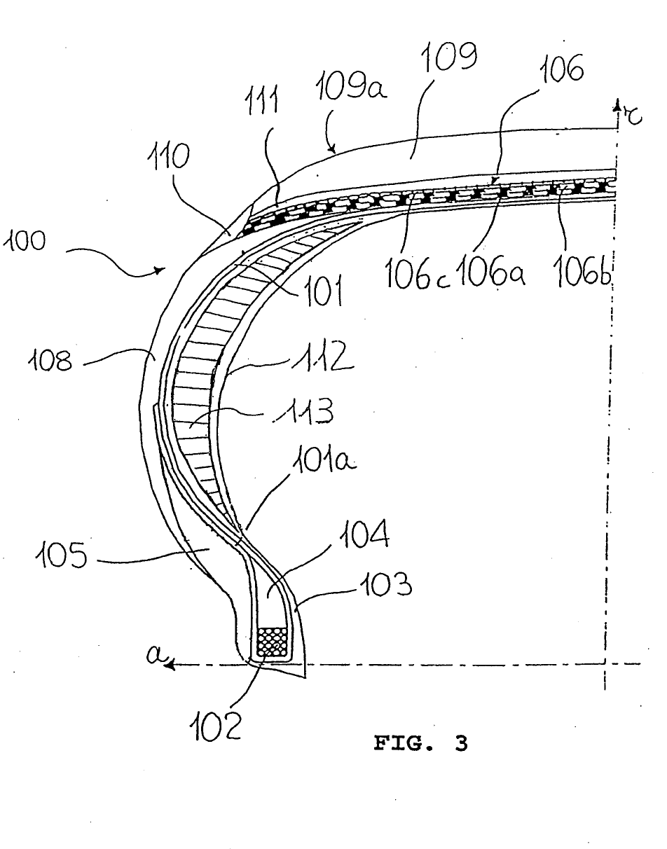

FIG. 3, shows a tyre (100) having a structure as described in FIG. 1 where a sidewall insert (113) which may be made according to the present invention, which extends radially from a position corresponding to the bead structure to a position corresponding to a tread lateral edge, is placed in an axially internal position with respect to the carcass ply: for example, as represented in FIG. 3, said sidewall insert is placed between the carcass ply (101) and the liner (112). Alternatively, in the case in which more carcass plies are present, a sidewall insert (113) is placed between two of said carcass plies (not represented in FIG. 3.) Alternatively, a sidewall insert is placed between the carcass ply and the side wall (not represent in FIG. 3). More than one sidewall insert may be present as disclosed, for example, in patent U.S. Pat. No. 5,238,040 or in European Patent EP 943,466.

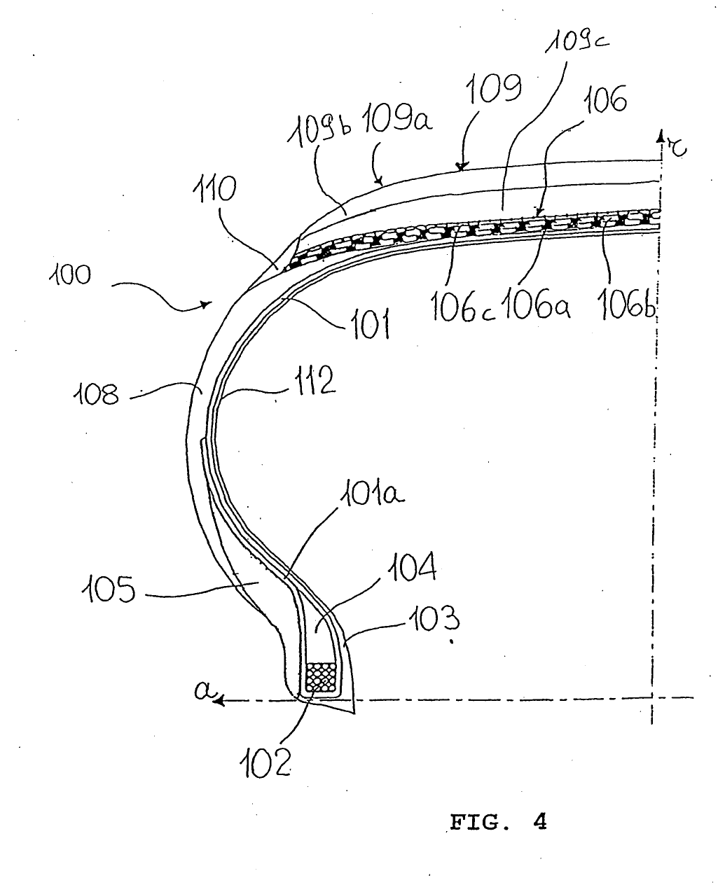

FIG. 4, shows a tyre (100) having a structure as described in FIG. 1 where a tread band (109) is of cap and base construction. More in particular, said tread band (109) comprises a radially inner layer or tread base (109c) and a radially outer layer or tread cap (109b): the tread base (109c) may be made according to the present invention.

As represented in FIG. 5, the tread base (109c) has a uniform thickness. In any case, the thickness of the tread base (109c) may also be not uniform but, for example, greater near its outer edges and/or at the central zone thereof.

With reference to FIG. 5, the production plant (200) includes an extruder (201) suitable for carrying out the masterbatch preparation according to the present invention. As schematically shown in FIG. 5, by means of feed hoppers (206) the extruder (201) is fed with the compounds necessary for producing the masterbatch. Preferably, the extruder is a co-rotating twin screw extruder.

Generally, the compounds are fed simultaneously to the extruder. For example, the elastomeric polymer (202) and the epoxidizing agent which may be selected from those above reported (203) are fed to the extruder through a feed hopper (206). Alternatively, the compounds may be fed to the extruder (201) through different feed hoppers (not represented in FIG. 5).

Each flow (202) and (203) is fed to the feed hopper (206) by means of different metering devices (205). Preferably said metering devices are loss-in-weight gravimetric feeders. Alternatively, each flow (202) and (203) may be fed to the feed hopper (206) by means of the same metering device (205) (not represented in FIG. 5).

Alternatively, a previously made epoxidized elastomeric polymer may be fed to the extruder (201) through a feed hopper (206) by means of a metering device (205).

FIG. 5 shows also a degassing unit schematically indicated by reference sign (208) from which a flow of the gases possibly generated during extrusion (207) exits.

The layered material (204) is fed to the extruder through a feed hopper (206). Preferably, the layered material is fed at the first side port of the extruder (not represented in FIG. 5).

The resulting masterbatch (210) is discharged from the extruder (201), e.g. in the form of a continuous strand, by pumping it through an extruder die (209) and is conveyed to a cooling device (211). A gear pump (not represented in FIG. 1) may be provided before said extruder die (209). After cooling, the resulting masterbatch may be granulated by means of a grinding device (not represented in FIG. 5).

Alternatively, the masterbatch (210) is discharged from the extruder (201) in the form of a subdivided product by pumping it through an extruder die (209) which may be provided with a perforated die plate equipped with knives (not represented in FIG. 5). The obtained subdivided product may be, e.g. in a granular form, with an average diameter of the granules generally of from 0.5 mm to 3 mm, preferably of from 1 mm to 2 mm, and a length generally of from 1 mm to 4 mm, preferably of from 1.5 mm to 3 mm.

The process for producing the tyre according to the present invention may be carried out according to techniques and using apparatus that are known in the art, as described, for example, in European Patents EP 199,064, and in patents U.S. Pat. No. 4,872,822 or U.S. Pat. No. 4,768,937, said process including at least one stage of manufacturing the crude tyre and at least one stage of vulcanizing this tyre.

More particularly, the process for producing the tyre comprises the steps of preparing, beforehand and separately from each other, a series of semi-finished products corresponding to the various structural elements of the tyre (carcass plies, belt structure, bead wires, fillers, sidewalls and tread band) which are then combined together using a suitable manufacturing machine. Next, the subsequent vulcanization step welds the above-mentioned semi-finished products together to give a monolithic block, i.e. the finished tyre.

The step of preparing the abovementioned semi-finished products will be preceded by a step of preparing and moulding the various crosslinkable elastomeric compositions, of which said semi-finished products are made, according to conventional techniques.

The crude tyre thus obtained is then passed to the subsequent steps of moulding and vulcanization. To this end, a vulcanization mould is used which is designed to receive the tyre being processed inside a moulding cavity having walls which are countermoulded to define the outer surface of the tyre when the vulcanization is complete.

Alternative processes for producing a tyre or parts of a tyre without using semi-finished products are disclosed, for example, in the abovementioned European Patent Applications EP 928,680 and EP 928,702.

According to one preferred embodiment, said structural elements are formed by a plurality of coils of a continuous elongated element. Said elongated element may be produced, for example, by extruding the crosslinkable elastomeric composition above disclosed. Preferably, said structural elements are assembled onto a support.

For the purposes of the present description and of the claims which follow, the term “support” is used to indicate the following devices:
an auxiliary drum having a cylindrical shape, said auxiliary drum preferably supporting a belt structure;
a shaping drum having a substantially toroidal configuration, said shaping drum preferably supporting at least one carcass structure with a belt structure assembled thereon;
a rigid support preferably shaped according to the inner configuration of the tyre.

Further details regarding said devices and the methods of forming and/or depositing the structural elements of the tyre on a support are described, for example, in International Patent Application WO 01/36185 and in European Patent EP 976,536 in the name of the Applicant, and in European Patent Applications: EP 968,814, EP 1,201,414 and EP 1,211,057.

The crude tyre can be moulded by introducing a pressurized fluid into the space defined by the inner surface of the tyre, so as to press the outer surface of the crude tyre against the walls of the moulding cavity. In one of the moulding methods widely practiced, a vulcanization chamber made of elastomeric material, filled with steam and/or another fluid under pressure, is inflated inside the tyre closed inside the moulding cavity. In this way, the crude tyre is pushed against the inner walls of the moulding cavity, thus obtaining the desired moulding. Alternatively, the moulding may be carried out without an inflatable vulcanization chamber, by providing inside the tyre a toroidal metal support shaped according to the configuration of the inner surface of the tyre to be obtained as described for example, in European Patent EP 1,189,744.

At this point, the step of vulcanizing the crude tyre is carried out. To this end, the outer wall of the vulcanization mould is placed in contact with a heating fluid (generally steam) such that the outer wall reaches a maximum temperature generally of from 100° C. to 230° C. Simultaneously, the inner surface of the tyre is heated to the vulcanization temperature using the same pressurized fluid used to press the tyre against the walls of the moulding cavity, heated to a maximum temperature of from 100° C. to 250° C. The time required to obtain a satisfactory degree of vulcanization throughout the mass of the elastomeric material may vary in general from 3 min to 90 min and depends mainly on the dimensions of the tyre. When the vulcanization is complete, the tyre is removed from the vulcanization mould.

The present invention will be further illustrated below by means of a number of preparation examples, which are given for purely indicative purposes and without any limitation of this invention.

### EXAMPLE 1

### Preparation of the Epoxidized Elastomeric Polymer in a Twin-Screw Extruder

The amounts of the components used are given in Table 1 (the amounts of the various components are given in phr).

TABLE 1

| | |
|---|---|
| EXAMPLE | 1 |
| IR | 100 |
| Succinic anhydride | 3.60 |
| sodium percarbonate | 4.28 |
| Water | 4.28 |

⁽*⁾: comparative.
IR: cis-1,4-polyisoprene (SKI3 - Nizhnekamskneftechim Export);
succinic anhydride: commercial product from Lonza;
sodium percarbonate: Oxyper ® 131S from Solvay.

The IR rubber was obtained in the form of granules having an average particles size diameter of about 3 mm-15 mm, by means of a rubber grinder. The so obtained granules, the succinic anhydride and the sodium percarbonate, both in granular form, were fed to the feed hopper of a co-rotating twin-screw extruder Maris TM40HT having a nominal screw diameter of 40 mm and a L/D ratio of 48. The maximum temperature of the extruder was 150° C. The extrusion head was kept at a temperature of 70° C.

The obtained epoxidized polymer was discharged from the extruder in the form of a continuous strand, was cooled at room temperature and granulated. A sample of the obtained epoxidized polymer was subjected to UV fluorescence analysis below reported in order to evaluate the amount of the epoxy groups.

### UV Fluorescence Analysis

The epoxidized elastomeric polymer obtained as above disclosed, was grounded into granules having an average particles size diameter of about 1 mm, by means of a rubber grinder.

The obtained granules were washed with water by means of a Soxhlet apparatus, in order to hydrolize the epoxy groups and to eliminate the reaction by-products. Subsequently, the granules were dried in an oven, at 70° C., for about 12 hours.

The dried granules (300 mg) were dissolved into 10 ml of anhydrous pyridine and were heated at 80° C., under stirring, for 30 min. Subsequently, 120 mg of 4-bromoethyl-6,7-dimethoxycoumarin, were added and the solution was maintained at 80° C., under stirring, for 6 hours.

Afterward, the solution was cooled at room temperature and 30 ml of methanol were gentle added: the obtained precipitated elastomeric polymer was washed in methanol twice and dried in an oven, at 70° C., for about 12 hours.

To 20 mg of the above dried elastomeric polymer, 5 ml of toluene were added and the obtained solution was heated under gentle reflux, under stirring, for 2 hours, at 80° C. Subsequently, the solution was diluted with hexane and subjected to UV fluorescence analysis by means of spectrometer Jaswco A 235.

The amount of the epoxy groups was obtained by the signal at 320 nm in comparison to a calibration curve derived from 4-carboxymethyl-7-methoxycumarin. The amount of the epoxy groups was calculated by the following formula:

$$mol \% = \frac{A / B}{2} \times 100$$

wherein A is the concentration of the fluorescent groups and B is the concentration of the elastomeric polymer.

It has to be noted that, the above analysis, evaluate also the presence of groups which may result from the decomposition of the epoxy groups such as, for example, vicinal diols or ester groups.

The epoxidized elastomeric polymer includes 0.5 mol % of epoxy groups relative to the total number of moles of monomers present in the elastomeric polymer.

### EXAMPLE 2

### Preparation of the Masterbatch in a Twin-Screw Extruder

The masterbatch was prepared as follows by using a production plant as reported in FIG. 5.

The amounts of the components used are given in Table 2 (the amounts of the various components are given in phr).

TABLE 2

| | |
|---|---|
| EXAMPLE | 2 |
| EPOXIDIZED-IR | 100 |
| Dellite ® 67G | 20 |

EPOXIDIZED-IR: epoxidized cis-1,4-polyisoprene obtained in Example 1;
Dellite ® 67G: organo-modified montmorillonite belonging to the smectite family (Laviosa Chimica Mineraria S.p.A.).

The epoxidized cis-1,4-polyisoprene, in granular form, was fed to the feed hopper of a co-rotating twin-screw extruder Maris TM40HT having a nominal screw diameter of 40 mm and a L/D ratio of 48.

The feeding was carried out by means of a loss-in-weight gravimetric feeder.

The organo-modified montmorillonite was added by means of a gravimetric loss-in-weight feeder at the first side port of the extruder (not represented in FIG. 5).

The maximum temperature of the extruder was 160° C. The extrusion head was kept at a temperature of 90° C.

The obtained masterbatch was discharged from the extruder in the form of a continuous strand, was cooled at room temperature in a cooling device and granulated.

### EXAMPLE 3

### Preparation of the Masterbatch in a Twin-Screw Extruder

The masterbatch was prepared as follows by using a production plant as reported in FIG. 5.

The amounts of the components used are given in Table 3 (the amounts of the various components are given in phr).

TABLE 3

| | |
|---|---|
| EXAMPLE | 3 |
| IR | 100 |
| Lonzabac ® MB | 2 |
| Dellite ® 67G | 20 |

IR: cis-1,4-polyisoprene (SKI3 - Nizhnekamskneftechim Export);
Lonzabac ® MB: magnesium bis(2-carboxylatemonoperoxybenzoic acid)hexahydrate (Lonza);
Dellite ® 67G: organo-modified montmorillonite belonging to the smectite family (Laviosa Chimica Mineraria S.p.A.).

The cis-1-4-polyisoprene was obtained in the form of granules having an average particles size diameter of about 3 mm-20 mm, by means of a rubber grinder. The so obtained granules, the Lonzabac® MB and the organo-modified montmorillonite, were fed to the feed hopper of a co-rotating twin-screw extruder Maris TM40HT having a nominal screw diameter of 40 mm and a L/D ratio of 48.

The maximum temperature in the extruder was 150° C. The extrusion head was kept at a temperature of 90° C.

The obtained masterbatch was discharged from the extruder in the form of a continuous strand, was cooled at room temperature in a cooling device and granulated.

The obtained masterbatch was subjected to UV fluorescence analysis operating as disclosed above.

The epoxidized elastomeric polymer includes 0.5 mol % of epoxy groups relative to the total number of moles of monomers present in the elastomeric polymer.

### EXAMPLES 4-8

### Preparation of the Elastomeric Compositions

The elastomeric compositions given in Table 4 were prepared as follows (the amounts of the various components are given in phr).

All the components, except sulphur and accelerator (DCBS), were mixed together in an internal mixer (model Pomini PL 1.6) for about 5 min (1^{st} Step). As soon as the temperature reached 145±5° C., the elastomeric material was discharged. The sulphur and the accelerator, were then added and mixing was carried out in an open roll mixer (2^{nd} Step).

TABLE 4

| | | | | | |
|---|---|---|---|---|---|
| EXAMPLE | 4 (*) | 5 (*) | 6 | 7 | 8 |

1^{st} STEP

| | | | | | |
|---|---|---|---|---|---|
| IR | 100 | — | — | — | — |
| N326 | 40 | 40 | 40 | 40 | 40 |
| Zinc oxide | 4 | 4 | 4 | 4 | 4 |
| Stearic acid | 2 | 2 | 2 | 2 | 2 |
| Antioxidant | 2 | 2 | 2 | 2 | 2 |
| X50S ® | 4 | 4 | 4 | 4 | 4 |
| Dellite ® 67G | 20 | 20 | 20 | — | — |
| ENR 25 | — | 100 | — | — | — |
| EPOXIDIZED-IR | — | — | 100 | — | — |
| Masterbatch | — | — | — | 120 | — |
| of Example 2 | | | | | |
| Masterbatch | — | — | — | — | 120 |
| of Example 3 | | | | | |

2^{nd} STEP

| | | | | | |
|---|---|---|---|---|---|
| DCBS | 1.8 | 1.8 | 1.8 | 1.8 | 1.8 |
| Sulphur | 2 | 2 | 2 | 2 | 2 |

(*): comparative.
IR: cis-1,4-polyisoprene (SKI3 - Nizhnekamskneftechim Export);
N326: carbon black;
Antioxidant: phenyl-p-phenylenediamine;
X50S ®: silane coupling agent comprising 50% by weight of carbon black and 50% by weight of bis(3-triethoxysilylpropyl) tetrasulphide (Degussa-Hüls);
Dellite ® 67G: organo-modified montmorillonite belonging to the smectite family (Laviosa Chimica Mineraria S.p.A.);
ENR 25: epoxidized natural rubber containing 25 mol % of epoxide groups (Epoxyprene ® 25 from Guthrie);
EPOXIDIZED-IR: modified cis-1,4-polyisoprene obtained in Example 1;
DCBS (accelerator): benzothiazyl-2-dicyclohexyl-sulfenamide (Vulkacit ® DZ/EGC - Bayer);

The Mooney viscosity ML(1+4) at 100° C. was measured, according to Standard ISO 289-1:1994, on the non-crosslinked elastomeric compositions obtained as described above. The results obtained are given in Table 5.

The static mechanical properties according to Standard ISO 37:1994 as well as hardness in IRHD degrees at 23° C. according to ISO standard 48:1994, were measured on samples of the abovementioned elastomeric compositions vulcanized at 170° C. for 10 min. The results obtained are given in Table 5.

Table 5 also shows the dynamic mechanical properties, measured using an Instron dynamic device in the traction-compression mode according to the following methods. A test piece of the crosslinked elastomeric composition (vulcanized at 170° C. for 10 min) having a cylindrical form (length=25 mm; diameter=12 mm), compression-preloaded up to a 10% longitudinal deformation with respect to the initial length, and kept at the prefixed temperature (23° C. or 70° C.) for the whole duration of the test, was submitted to a dynamic sinusoidal strain having an amplitude of ±3.5% with respect to the length under pre-load, with a 100 Hz frequency. The dynamic mechanical properties are expressed in terms of dynamic elastic modulus (E′) and Tan delta (loss factor) values. The Tan delta value is calculated as a ratio between viscous modulus (E″) and elastic modulus (E′).

1. Tyre comprising at least one structural element obtained by crosslinking a crosslinkable elastomeric composition comprising:
(a) a crosslinkable elastomeric base comprising at least 10 phr of (a₁) at least one epoxidized elastomeric polymer including less than 10 mol % of epoxy groups relative to the total number of moles of monomers present in the elastomeric polymer;
(b) from 2 phr to 50 phr of at least one layered material.

2. Tyre according to claim 1, comprising:
a carcass structure of a substantially toroidal shape, having opposite lateral edges associated with respective right-hand and left-hand bead structures, said bead structures comprising at least one bead core and at least one bead filler;
a belt structure applied in a radially external position with respect to said carcass structure,
a tread band radially superimposed on said belt structure;
a pair of sidewalls applied laterally on opposite sides with respect to said carcass structure;
at least one structural element selected from bead filler, sidewall insert, tread underlayer, tread base, obtained by crosslinking a crosslinkable elastomeric composition comprising:
(a) a crosslinkable elastomeric base comprising at least 10 phr of (a₁) at least one epoxidized elastomeric polymer including less than 10 mol % of epoxy groups relative to the total number of moles of monomers present in the elastomeric polymer;
(b) from 2 phr to 50 phr of at least one layered material.

3. Tyre according to claim 1 or 2, wherein said crosslinkable elastomeric base comprises from 30 phr to 100 phr, of (a₁) at least one epoxidized elastomeric polymer.

4. Tyre according to any one of the preceding claims, wherein said epoxidized elastomeric polymer includes from 0.1 mol % to 5 mol % of epoxy groups relative to the total number of moles of monomers present in the elastomeric polymer.

5. Tyre according to any one of the preceding claims, wherein said layered material is present in an amount of from 5 phr to 30 phr.

6. Tyre according to any one of the preceding claims, wherein said layered material has an individual layer thickness of from 0.01 nm to 30 nm.

7. Tyre according to claim 6, wherein said layered material has an individual layer thickness of from 0.05 nm to 15 nm.

8. Tyre according to any one of the preceding claims, wherein said crosslinkable elastomeric base (a) comprises (a₂) at least one second elastomeric-polymer in an amount not higher than 90 phr.

9. Tyre according to claim 8, wherein said crosslinkable elastomeric base (a) comprises (a₂) at least one second elastomeric polymer in an amount of from 0 phr to 70 phr.

10. Tyre according to any one of the preceding claims, wherein said sidewall insert extends radially from a position corresponding to the bead structure to a position corresponding to a tread lateral edge.

11. Tyre according to any one of the preceding claims, wherein said tread underlayer is a layer of crosslinked elastomeric composition applied in a radially internal position with respect to said tread band.

12. Tyre according to any one of the preceding claims, wherein said tread band is of cap and base construction and comprises a radially inner layer or tread base and a radially outer layer or tread cap.

13. Tyre according to any one of the preceding claims, wherein said structural element has a tensile modulus at 100% elongation (100% Modulus) not lower than 3 MPa.

14. Tyre according to claim 13, wherein said structural element has a tensile modulus at 100% elongation (100% Modulus) of from 4.5 MPa to 16 MPa.

15. Tyre according to any one of the preceding claims, wherein said structural element has a dynamic elastic modulus (E′), measured at 23° C., not lower than 12 MPa.

16. Tyre according to claim 15, wherein said structural element has a dynamic elastic modulus (E′), measured at 23° C., of from 13 MPa to 50 MPa.

17. Tyre according to any one of the preceding claims, wherein said structural element has a dynamic elastic modulus (E′), measured at 70° C., not lower than 8 MPa.

18. Tyre according to claim 17, wherein said structural element has a dynamic elastic modulus (E′), measured at 70° C., of from 9 MPa to 40 MPa.

19. Tyre according to any one of the preceding claims, wherein said structural element has a IRHD hardness, measured at 23° C., not lower than 70.

20. Tyre according to claim 19, wherein said structural element has a IRHD hardness, measured at 23° C., of from 75 to 95.

21. Tyre according to any one of the preceding claims, wherein said epoxy groups are introduced into the elastomeric polymer during the production of said elastomeric polymer by co-polymerization with at least one epoxy compound containing at least one ethylenic unsaturation.

22. Tyre according to any one of claims 1 to 20, wherein said epoxy groups are introduced into the elastomeric polymer, by reacting said elastomeric polymer, in solution, with at least one epoxidizing agent.

23. Tyre according to any one of claims 1 to 20, wherein said epoxy groups are introduced into the elastomeric polymer by means of a process comprising:
feeding at least one elastomeric polymer and at least one epoxidizing agent to a mixing device;
mixing and softening said mixture obtaining an epoxidized elastomeric polymer;
discharching the obtained epoxidized elastomeric polymer from said mixing device.

24. Tyre according to any one of claims 1 to 20, wherein said epoxy groups are introduced into the elastomeric polymer by means of a process comprising:
feeding at least one elastomeric polymer to a mixing device;
feeding at least one hydrogen peroxide precursor to said mixing device;
feeding at least one carboxylic acid or a derivative thereof to said mixing device;
mixing and reacting, in the presence of water, said at least one elastomeric polymer with said at least one hydrogen peroxide precursor and said at least one carboxylic acid or a derivative thereof, to obtain an epoxidized elastomeric polymer;
discharging the resulting epoxidized elastomeric polymer from said mixing device.

25. Tyre according to any one of the preceding claims, wherein the elastomeric polymer utilized in the production of said epoxidized elastomeric polymer is selected from sulphur-crosslinkable elastomeric polymers or copolymers with an unsaturated chain having a glass transition temperature below 20° C.

26. Tyre according to claim 25, wherein the elastomeric polymer utilized in the production of said epoxidized elastomeric polymer is selected from: natural or synthetic cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

27. Tyre according to any one of claims 1 to 25, wherein the elastomeric polymer utilized in the production of said epoxidized elastomeric polymer is selected from elastomeric polymers of one or more monoolefins with an olefinic comonomer and at least one diene, or derivatives thereof.

28. Tyre according to claim 27, wherein the elastomeric polymer utilized in the production of said epoxidized elastomeric polymer is selected from: ethylene/propylene/diene copolymers (EPDM); polyisobutene; butyl rubbers; halobutyl rubbers; or mixtures thereof.

29. Tyre according to any one of the preceding claim, wherein said layered material (b) is selected from phyllosilicates such as: smectites such as, montmorillonite, bentonite, nontronite, beidellite, volkonskoite, laponite, hectorite, saponite, sauconite, magadite, kenyasite, stevensite; vermiculite; halloisite; sericite; aluminate oxides; hydrotalcite; or mixtures thereof.

30. Tyre according to claim 29, wherein said layered material (b) is montmorillonite.

31. Tyre according to any one of the preceding claims, wherein said layered material (b) is treated with a compatibilizing agent.

32. Tyre according to claim 31, wherein said compatibilizing agent is selected from the quaternary ammonium or phosphonium salts having general formula (I): 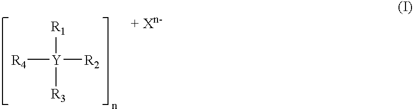
wherein:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH wherein R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group possibly containing hetero atom such as oxygen, nitrogen or sulphur;
Xⁿ⁻ represents an anion such as the chlorine ion, the sulphate ion or the phosphate ion;
n represents 1, 2 or 3.

33. Tyre according to any one of the preceding claims, wherein said epoxidized elastomeric polymer is pre-mixed with said layered material in order to obtain a masterbatch.

34. Tyre according to claim 33, wherein said masterbatch is obtained by means of a process comprising the following steps:
feeding at least one epoxidized elastomeric polymer and at least one layered material to a mixing device;
mixing and softening said mixture so as to obtain a masterbatch;
discharching the obtained masterbatch from said mixing device.

35. Tyre according to claim 33, wherein said masterbatch is obtained by means of a process comprising the following steps:
feeding at least one elastomeric polymer, at least one epoxidizing agent, and at least one layered material, into a mixing device
mixing and softening said mixture so as to obtain a masterbatch;
discharching the obtained masterbatch from said mixing device.

36. Tyre according to claim 33, wherein said masterbatch is obtained by means of a process comprising the following steps:
feeding at least one elastomeric polymer to a mixing device;
feeding at least one hydrogen peroxide precursor to said mixing device;
feeding at least one carboxylic acid or a derivative thereof to said mixing device;
mixing and reacting, in the presence of water, said at least one elastomeric polymer with said at least one hydrogen peroxide precursor and said at least one carboxylic acid or a derivative thereof;
feeding at least one layered inorganic material to said mixing device;
mixing and softening said mixture obtaining a masterbatch;
discharching the obtained masterbatch from said mixing device.

37. Tyre according to any one of the preceding claims, wherein said crosslinkable elastomeric base (a) comprises (a₂) at least one second elastomeric polymer selected from:
natural or synthetic cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof;
ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof;
elastomeric polymer of one or more monoolefins with an olefinic comonomer, such as ethylene/propylene copolymers (EPR), or mixtures thereof.

38. Tyre according to any one of the preceding claims, wherein said crosslinkable elastomeric composition comprises from 0 phr to 120 phr of (c) at least one carbon black reinforcing filler.

39. Tyre according to claim 38, wherein said crosslinkable elastomeric composition comprises from 20 phr to 90 phr of (c) at least one carbon black reinforcing filler.

40. Tyre according to any one of the preceding claims, wherein said crosslinkable elastomeric composition comprises (d) at least one silane coupling agent.

41. Tyre according to claim 40, wherein said silane coupling agent (d) is selected from those having at least one hydrolizable silane group which may be identified by the following general formula (II):
(R)₃Si—CₙH₂ₙ—X (II)
wherein the groups R, which may be identical or different, are selected from: alkyl, alkoxy or aryloxy groups or from halogen atoms, on condition that at least one of the groups R is an alkoxy or aryloxy group; n is an integer between 1 and 6 inclusive; X is a group selected from: nitroso, mercapto, amino, epoxide, vinyl, imide, chloro, —(S)ₘCₙH₂ₙ—Si—(R)₃ or —S—COR in which m and n are integers between 1 and 6 inclusive and the groups R are defined as above.

42. Tyre according to claim 40 or 41, wherein said silane coupling agent (d) is present in the crosslinkable elastomeric composition in an amount of from 0 phr to 10 phr.

43. Tyre for vehicle wheels according to claim 42, wherein said silane coupling agent (d) is present in the crosslinkable elastomeric composition in an amount of from 0.5 phr to 5 phr.

44. Tyre according to any one of the preceding claims, wherein at least one additional reinforcing filler is present in said crosslinkable elastomeric composition in an amount of from 0 phr to 120 phr.

45. Tyre according to claim 44, wherein said additional reinforcing filler is silica.

46. Tyre for vehicle wheels according to claim 45, wherein at least one further silane coupling agent (d) according to claim 41 is present.

47. Crosslinkable elastomeric composition comprising:
(a) a crosslinkable elastomeric base comprising at least 10 phr of (a₁) at least one epoxidized elastomeric polymer including less than 10 mol % of epoxy groups relative to the total number of moles of monomers present in the elastomeric polymer;
(b) from 2 phr to 50 phr of at least one layered material.

48. Crosslinkable elastomeric composition according to claim 47, wherein said crosslinkable elastomeric base comprises from 30 phr to 100 phr, of (a₁) at least one epoxidized elastomeric polymer.

49. Crosslinkable elastomeric composition according to claim 47 or 48, wherein said epoxidized elastomeric polymer includes from 0.1 mol % to 5 mol % of epoxy groups relative to the total number of moles of monomers present in the elastomeric polymer.

50. Crosslinkable elastomeric composition according to any one of claims 47 to 49, wherein said layered material is present in an amount of from 5 phr to 30 phr.

51. Crosslinkable elastomeric composition according to any one of claims 47 to 50, wherein said layered material has an individual layer thickness of from 0.01 nm to 30 nm.

52. Crosslinkable elastomeric composition according to claim 51, wherein said layered material has an individual layer thickness of from 0.05 nm to 15 nm.

53. Crosslinkable elastomeric composition according to any one of claims 47 to 52, wherein said epoxidized elastomeric polymer is defined according to any one of claims 21 to 28.

54. Crosslinkable elastomeric composition according to any one of claims 47 to 53, wherein said layered material is defined according to claim 29 or 30.

55. Crosslinkable elastomeric composition according to claim 54, wherein said layered material is added as such.

56. Crosslinkable elastomeric composition according to claim 54, wherein said layered material is added after being treated with at least one compatibilizing agent which is defined according to claim 32.

57. Crosslinkable elastomeric composition according to any one of claims 47 to 56, wherein said epoxidized elastomeric polymer is pre-mixed with said layered material in order to obtain a masterbatch.

58. Crosslinkable elastomeric composition according to claim 57, wherein said masterbatch is obtained according to any one of claims 34 to 36.

59. Crosslinkable elastomeric composition according to any one of claims 47 to 58, wherein said crosslinkable elastomeric base (a) comprises (a₂) at least one second elastomeric polymer defined according to claim 37.

60. Crosslinkable elastomeric composition according to any one of claims 47 to 59, wherein said crosslinkable elastomeric composition comprises at least one carbon black defined according to claim 38 or 39.

61. Crosslinkable elastomeric composition according to any one of claims 47 to 60, wherein said crosslinkable elastomeric composition comprises at least one silane coupling agent (d) defined according to any one of claims 41 to 43.

62. Crosslinkable elastomeric composition according to any one of claims 47 to 61, wherein at least one additional reinforcing filler is present in an amount of from 0 phr to 120 phr.

63. Crosslinkable elastomeric composition according to claim 62, wherein the additional reinforcing filler is silica.

64. Crosslinkable elastomeric composition according to claim 63, wherein at least one silane coupling agent (d) defined according to any one of claims 41 to 43 is present.

65. Crosslinked manufactured article obtained by crosslinking a crosslinkable elastomeric composition defined according to any one of claims 47 to 64.
